(19) United States
(12) Patent Application Publication
(10) Pub. No.: US 2025/0009027 A1
(43) Pub. Date: Jan. 9, 2025

(54) HEATING CORE ASSEMBLY, ATOMIZATION DEVICE AND AEROSOL GENERATING DEVICE

(71) Applicant: SHENZHEN WOODY VAPES TECHNOLOGY CO., LTD., Shenzhen (CN)

(72) Inventors: Jianhua WENG, Shenzhen (CN); Youming LIU, Shenzhen (CN); Yanming NIU, Shenzhen (CN)

(73) Assignee: SHENZHEN WOODY VAPES TECHNOLOGY CO., LTD., Shenzhen (CN)

(21) Appl. No.: 18/757,543

(22) Filed: Jun. 28, 2024

(30) Foreign Application Priority Data
Jul. 4, 2023 (CN) 202321743868.1

(51) Int. Cl. A24F 40/46; A24F 40/10; A24F 40/30; A24F 40/44; A24F 40/485; A24F 40/51

(52) U.S. Cl. CPC A24F 40/46; A24F 40/10; A24F 40/30; A24F 40/44; A24F 40/485; A24F 40/51

(57) ABSTRACT

A heating core assembly includes a heating core and a heating control board. The heating core has N pins arranged at intervals to divide the heating core into N−1 heating parts, where Nis an integer and N≥3. The heating control board is electrically connected to each of the N pins to control respective voltages at the N pins, so that the N−1 heating parts work in one of a first mode in which at least two of the N−1 heating parts work in turn, a second mode in which at least two of the N−1 heating parts are electrically connected in parallel, and a third mode in which at least two of the N−1 heating parts are electrically connected in series.

### CROSS-REFERENCE TO RELATED APPLICATION

This application claims the priority to Chinese Patent Application No. 202321743868.1, filed on Jul. 4, 2023, the disclosure of which is incorporated herein by reference in its entirety.

### TECHNICAL FIELD

The present disclosure relates to atomization technologies, and more particularly, to a heating core assembly, an atomization device, and an aerosol generating device.

### BACKGROUND

Generally, an aerosol generating device includes a nozzle, an atomization device, and a power supply device. If a heating core inside the atomization device operates for a long time, it may cause carbon deposits. The carbon deposits may damage the heating core and reduce its service life. The carbon deposits will also affect the atomization efficiency of the heating core and result in a fast decay of taste. In addition, the heating core has a fixed resistance, so that the amount of the mist output by the atomization device could not be adjusted, and the personalized needs of different users cannot be met.

### SUMMARY

According to one or more embodiments of the present disclosure, a heating core assembly includes a heating core and a heating control board. The heating core includes N pins arranged at intervals, the N pins divide the heating core into N−1 heating parts, N≥3, and the heating control board is connected to each of the N pins and is configured to control respective voltages at the N pins, so that the N−1 heating parts work in turn, in parallel, or in series.

According to one or more embodiments of the present disclosure, an atomization device includes an oil storage tube, an atomization tube provided within the oil storage tube, and the above heating core assembly. The heating core is disposed within the atomization tube, and an outer side of the heating core is covered with cotton.

According to one or more embodiments of the present disclosure, an aerosol generating device includes a housing, a nozzle, a power supply device and the above atomization device. The atomization device and the power supply device are both disposed within the housing, and the power supply device is located below the atomization device and is connected to the heating control board.

### BRIEF DESCRIPTION OF THE DRAWINGS

FIG. 1 is an exploded view of an aerosol generating device according to one or more embodiments of the present disclosure.

FIG. 2 is a cross-sectional view of an aerosol generating device according to one or more embodiments of the present disclosure.

FIG. 3 is a schematic perspective view of a heating core according to one or more embodiments of the present disclosure.

FIG. 4 is a schematic perspective view of an isolation silica gel member according to one or more embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

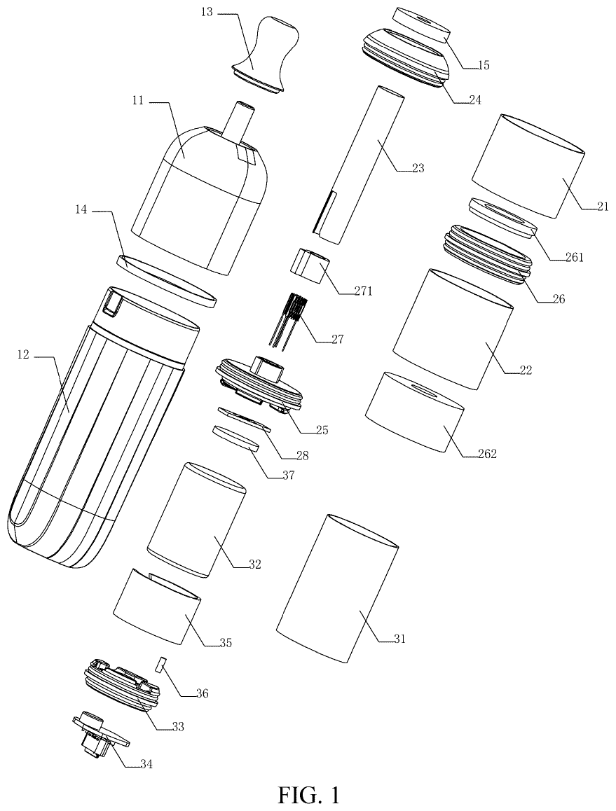

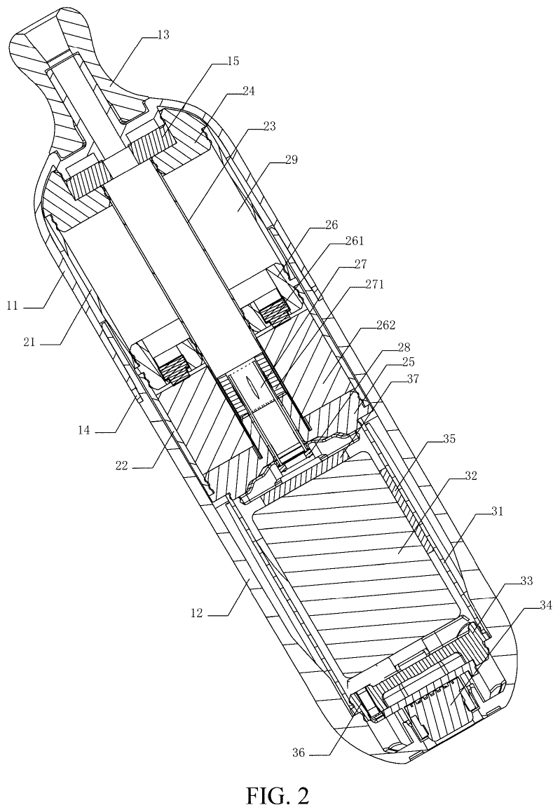

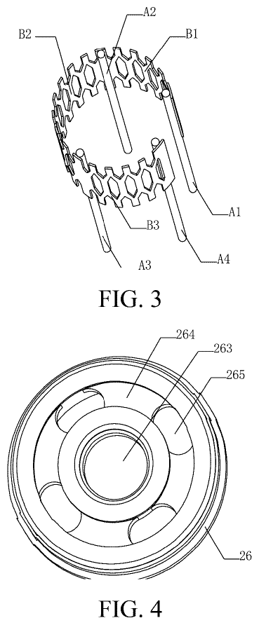

As shown in FIGS. 1 to 4, in one or more embodiments of the present disclosure, an aerosol generating device includes a housing, a nozzle 13, an atomization device and a power supply device. The atomization device includes an upper oil storage part 21, a lower oil storage part 22, an atomization tube 23, top silica gel member 24, bottom silica gel member 25, isolation silica gel member 26, an oil control ceramic ring 261, an oil storage cotton 262, a heating core 27, wrapping cotton 271, and a heating control board 28.

The upper end of the upper oil storage part 21 is sealed with the top silica gel member 24, the lower end of the upper oil storage part 21 is sealed with the upper end of the isolation silica gel member 26, the upper end of the lower oil storage part 22 is sealed with the lower end of the isolation silica gel member 26, and the lower end of the lower oil storage part 22 is sealed with the bottom silica gel member 25. An upper oil filling region 29 is formed inside the upper oil storage part 21, and a lower oil filling region is formed inside the lower oil storage part 22. The isolation silica gel member 26 separates the upper oil filling region 29 from the lower oil filling region. The isolation silica gel member 26 is provided with a center hole 263 and an annular groove 264 concentric with the center hole 263, and an oil passage hole 265 connecting the upper oil-filling region 29 and the lower oil-filling region is provided in the annular groove 264. The upper end of the atomization tube 23 is sealed with the top silica gel member 24, and the lower end of the atomization tube 23 is sealed with the bottom silica gel member 25 through the center hole 263 of the isolation silica gel member 26. The oil storage cotton 262 is disposed in the lower oil filling region, and the outer side of the lower end of the atomization tube 23 is sleeved with the oil storage cotton 262. The heating core 27 is disposed on the inner side of the lower end of the atomization tube 23, and the outer side of the heating core 27 is sleeved with the wrapping cotton 271. The pin of the heating core 27 is connected to the heating control board 28 through the bottom silica gel member 25. The oil control ceramic ring 261 is embedded in the annular groove 264 and abuts against the oil passage hole 265. The oil within the upper oil-filling region 29 flows to the oil storage cotton 262 within the lower oil filling region through the gap between the oil passage hole 265 and the oil control ceramic ring 261, and supplies oil to the heating core 27 through the wrapping cotton 271.

The heating core 27 has a mesh structure. The heating core 27 includes four pins A1-A4 arranged at intervals, and the four pins divide the heating core 27 into three heating parts B1-B3. The heating control board 28 is connected to each of the four pins. The heating control board 28 includes a printed circuit board (PCB), a control chip and two connection terminals provided on the PCB. The two connection terminals are connected to the positive output terminal and the negative output terminal of the power supply device, respectively. The four pins of the heating core 27 are soldered on the PCB. A switch control circuit is printed on the PCB, and the four pins of the heating core 27 are electrically connected to the control chip through the switch control circuit. The control chip controls each of the voltages at the four pins so that the three heating parts work in turn, in parallel, or in series.

When the heating parts operate in parallel, the three heating parts may operate in parallel, or two of the three heating parts may operate in parallel. For example, based on the first parallel control instruction from the control chip, the switch control circuit on the PCB controls the pin A1 and the pin A3 to be connected to the positive output terminal of the power supply device, and controls the pin A2 and the pin A4 to be connected to the negative output terminal of the power supply device, so that the three heating parts of the heating core 27 operate in parallel. For another example, based on the second parallel control instruction from the control chip, the switch control circuit on the PCB controls the pin A1 and the pin A3 to be connected to the positive output terminal of the power supply device, controls the pin A2 to be connected to the negative output terminal of the power supply device, and controls the pin A4 not to be connected to both the positive output terminal and the negative output terminal of the power supply device, so that two (B1 and B2) of the three heating parts of the heating core 27 operate in parallel.

When the heating parts operate in series, the three heating parts may operate in parallel, or two of the three heating parts may operate in series. For example, based on the first parallel control instruction from the control chip, the switch control circuit on the PCB controls the pin A1 to be connected to the positive output terminal of the power supply device, controls the pin A4 to be connected to the negative output terminal of the power supply device, and controls each of the pin A2 and the pin A3 not to be connected to the positive output terminal or the negative output terminal of the power supply device, so that the three heating parts of the heating core 27 operate in series. For another example, based on the second parallel control instruction from the control chip, the switch control circuit on the PCB controls the pin A1 to be connected to the positive output terminal of the power supply device, controls the pin A3 to be connected to the negative output terminal of the power supply device, and controls each of the pin A2 and the pin A4 not to be connected to the positive output terminal or the negative output terminal of the power supply device, so that the two (B1 and B2) of the heating core 27 operate in series.

The power supply device includes a gas guide tube 31, a battery 32, a fixing cotton 35, an earpiece silica gel member 33, a printed circuit board assembly (PCBA) 34, a gas passage needle 36, and first oil absorbing cotton 37. The upper end of the gas guide tube 31 is sealed with the lower end of the bottom silica gel member 25 of the atomization device. The battery 32 is disposed within the gas guide tube 31. The first oil absorbing cotton 37 is disposed between the bottom silica gel member 25 and the battery 32. The fixing cotton 35 is disposed between the outer side of the battery 32 and the inner wall of the gas guide tube 31. The lower end of the gas guide tube 31 is sealed with the earpiece silica gel member 33. The PCBA 34 is fixed to a side of the earpiece silica gel member 33 away from the battery 32 and is electrically connected to the battery 32. The gas passage needle 36 is disposed on the earpiece silica gel member 33.

The housing includes an upper housing 11 and a lower housing 12. The upper housing 11 is in a threaded connection with the lower housing 12. A decoration ring 14 is provided at the connection position between the upper housing 11 and the lower housing 12. The atomization device and the power supply device are both disposed in the housing, and the power supply device is located below the atomization device and connected to the heating control board 28. The nozzle 13 is connected to the atomization tube 23, and the second oil absorbing cotton 15 is disposed at a position within the upper housing 11 opposite to the atomization tube 23. The second oil absorbing cotton 15 can prevent contamination of the nozzle 13 caused by leakage of oil.

In one or more embodiments of the present disclosure, the number of the pins of the heating core may be three, five, six or other numbers. Accordingly, the number of the heating parts may be two, four, five or other numbers. Multiple heating parts of the heating core 27 work in turn, in parallel or in series under the control of the heating control board 28. When the multiple heating parts work in turn, each of the heating parts may work in turn one by one. Alternatively, the multiple heating parts may be divided into multiple groups, and work in turn group by group. For example, when the heating core includes six heating parts which may be divided into three groups, the three groups of heating parts work in turn, and two of the heating parts operate at the same time. When multiple heating parts operate in parallel, all of the heating parts may operate in parallel, or some of the heating parts may operate in parallel. For example, when the heating core includes four heating parts, the four heating parts may be connected in parallel, or any two or three of the heating parts may be connected in parallel. When multiple heating parts are connected in series, all of the heating parts may operate in series, or some of the heating parts may operate in series. For example, when the heating core includes four heating parts, the four heating parts may be connected in series, or any two or three of the heating parts may be connected in series.

In one or more embodiments of the present disclosure, the upper oil storage part and the lower oil storage part may be integrally formed into one oil storage tube, and the isolation silica gel member is installed in the oil storage tube to divide the inner space of the oil storage tube into an upper oil filling region and a lower oil filling region, and finally the flow rate of the oil flowing from the upper oil storage part to the lower oil storage part is controlled by the oil control ceramic ring installed on the isolation silica gel member.

In one or more embodiments of the present disclosure, the upper oil storage part and the lower oil storage part may be integrally formed into one oil storage tube, and the isolation silica gel member and the oil control ceramic ring are not installed in the oil storage tube.

In one or more embodiments of the present disclosure, it is not necessary that the power supply device is limited to the configuration of the power supply device according to one or more embodiments of the present disclosure shown in FIGS. 1 to 4, and the power supply device may be realized by a general power supply device.

In one or more embodiments of the present disclosure, the housing may also include a left housing and a right housing which enclose to form the housing.

The aerosol generating device according to one or more embodiments of the present disclosure has the beneficial technical effect as follows.

The heating core is divided into multiple heating parts, and the multiple heating parts may work in turn, in parallel or in series under the control of the heating control board. The output resistance of the heating core is variable, so that the amount of the atomized mist output can be adjusted, thereby achieving multiple adjustable power levels to meet the personalized needs of different users. Furthermore, the multiple heating parts work in turn, so that a problem of carbon deposits caused by long-time operation of the heating core can be prevented.

The multiple heating parts of the heating core work in turn, so that a problem of carbon deposits caused by long-time operation of the heating core can also be prevented.

The inner space of the oil storage tube is divided into the upper oil filling region and the lower oil filling region by the isolation silica gel member, the oil within the upper oil filling region flows to the oil storage cotton within the lower oil filling region through the gap between the oil passage hole and the oil control ceramic ring, and the oil is supplied to the heating core through the wrapping cotton. The oil control ceramic ring may be used to effectively control the flow rate of the oil, thereby preventing oil leakage caused by excessive oil in the oil storage cotton.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A heating core assembly, comprising a heating core and a heating control board,
wherein the heating core has N pins arranged at intervals to divide the heating core into N−1 heating parts, where N is an integer and N≥3; and
the heating control board is electrically connected to each of the N pins to control respective voltages at the N pins, so that the N−1 heating parts work in one of a first mode in which at least two of the N−1 heating parts work in turn, a second mode in which at least two of the N−1 heating parts are electrically connected in parallel, and a third mode in which at least two of the N−1 heating parts are electrically connected in series.

2. The heating core assembly of claim 1, wherein the heating core has a mesh structure.

3. The heating core assembly of claim 1, wherein the heating control board comprises a printed circuit board (PCB) and a control chip disposed on the PCB;
the N pins are soldered to the PCB; and
the control chip is configured to control the respective voltages at the N pins.

4. The heating core assembly of claim 3, wherein N is equal to 4, and the N pins comprise a first pin, a second pin, a third pin and a fourth pin arranged in sequence;
the PCB is provided with two connection terminals respectively connected to a positive output terminal and a negative output terminal of a power supply device;
a switch control circuit is printed on the PCB and electrically connected to the control chip; and
each of the first pin, the second pin, the third pin and the fourth pin is electrically connected to each of the two connection terminals through the switch control circuit.

5. The heating core assembly of claim 4, wherein the switch control circuit is configured to, based on a first control instruction from the control chip, control both the first pin and the third pin to be electrically connected to the positive output terminal and control both the second pin and the fourth pin to be electrically connected to the negative output terminal, so that the N−1 heating parts are electrically connected in parallel.

6. The heating core assembly of claim 4, wherein the switch control circuit is configured to, based on a second control instruction from the control chip, control the first pin to be electrically connected to the positive output terminal, control the fourth pin to be electrically connected to the negative output terminal, and control each of the second pin and the third pin to be electrically disconnected from each of the positive output terminal and the negative output terminal, so that the N−1 heating parts are electrically connected in series.

7. An atomization device, comprising an oil storage tube, an atomization tube provided within the oil storage tube, and a heating core assembly comprising a heating core and a heating control board,
wherein the heating core is disposed within the atomization tube, and an outer side of the heating core is covered with a cotton;
the heating core has N pins arranged at intervals to divide the heating core into N−1 heating parts, where N is an integer and N≥3; and
the heating control board is electrically connected to each of the N pins to control respective voltages at the N pins, so that the N−1 heating parts work in one of a first mode in which at least two of the N−1 heating parts work in turn, a second mode in which at least two of the N−1 heating parts are electrically connected in parallel, and a third mode in which at least two of the N−1 heating parts are electrically connected in series.

8. The atomization device of claim 7, wherein the heating control board comprises a printed circuit board (PCB) and a control chip disposed on the PCB;
the N pins are soldered to the PCB; and
the control chip is configured to control the respective voltages at the N pins.

9. The atomization device of claim 8, wherein N is equal to 4, and the N pins comprise a first pin, a second pin, a third pin and a fourth pin arranged in sequence;
the PCB is provided with two connection terminals respectively connected to a positive output terminal and a negative output terminal of a power supply device;
a switch control circuit is printed on the PCB and electrically connected to the control chip; and
each of the first pin, the second pin, the third pin and the fourth pin is electrically connected to each of the two connection terminals through the switch control circuit.

10. The atomization device of claim 9, wherein the switch control circuit is configured to, based on a first control instruction from the control chip, control both the first pin and the third pin to be electrically connected to the positive output terminal and control both the second pin and the fourth pin to be electrically connected to the negative output terminal, so that the N−1 heating parts are electrically connected in parallel.

11. The atomization device of claim 9, wherein the switch control circuit is configured to, based on a second control instruction from the control chip, control the first pin to be electrically connected to the positive output terminal, control the fourth pin to be electrically connected to the negative output terminal, and control each of the second pin and the third pin to be electrically disconnected from each of the positive output terminal and the negative output terminal, so that the N−1 heating parts are electrically connected in series.

12. The atomization device according to claim 7, wherein an inner space of the oil storage tube is divided into a first oil filling region and a second oil filling region by an isolation silica gel member;
an oil storage cotton is disposed in the second oil filling region to cover an outer side of a second end of the atomization tube;
the isolation silica gel member is provided with an oil passage hole connecting the first oil filling region with the second oil filling region, and an oil control ceramic ring abutting against the oil passage hole.

13. The atomization device according to claim 7, wherein the oil storage tube comprises a first oil storage part having a first oil filling region, and a second oil storage part having a second oil filling region;
a first end of the first oil storage part is sealed with a top silica gel member, and a second end of the first oil storage part is sealed with a first end of an isolation silica gel member;
a first end of the second oil storage part is sealed with a second end of the isolation silica gel member, and a second end of the second oil storage part is sealed with a bottom silica gel member;
a first end of the atomization tube is sealed with the top silica gel member, and a second end of the atomization tube passes through the isolation silica gel member and is sealed with the bottom silica gel member;
the isolation silica gel member is provided with an oil passage hole connecting the first oil filling region with the second oil filling region, and an oil control ceramic ring abutting against the oil passage hole;
an oil storage cotton is disposed in the second oil storage part to cover an outer side of the second end of the atomization tube; and
the heating core is disposed inside the second end of the atomization tube, and the N pins pass through the bottom silica gel member and are connected to the heating control board.

14. An aerosol generating device, comprising a housing, a nozzle, a power supply device and an atomization device,
wherein the atomization device comprises an oil storage tube, an atomization tube provided within the oil storage tube, and a heating core assembly comprising a heating core and a heating control board;
both the atomization device and the power supply device are disposed within the housing, and the power supply device is located below the atomization device and is electrically connected to the heating control board;
the heating core is disposed within the atomization tube, and an outer side of the heating core is covered with a cotton;
the heating core has N pins arranged at intervals to divide the heating core into N−1 heating parts, where N is an integer and N≥3; and
the heating control board is electrically connected to each of the N pins to control respective voltages at the N pins, so that the N−1 heating parts work in one of a first mode in which at least two of the N−1 heating parts work in turn, a second mode in which at least two of the N−1 heating parts are electrically connected in parallel, and a third mode in which at least two of the N−1 heating parts are electrically connected in series.

15. The aerosol generating device of claim 14, wherein the heating control board comprises a printed circuit board (PCB) and a control chip disposed on the PCB;
the N pins are soldered to the PCB; and
the control chip is configured to control the respective voltages at the N pins.

16. The aerosol generating device of claim 15, wherein N is equal to 4, and the N pins comprise a first pin, a second pin, a third pin and a fourth pin arranged in sequence;
the PCB is provided with two connection terminals respectively connected to a positive output terminal and a negative output terminal of the power supply device;
a switch control circuit is printed on the PCB and electrically connected to the control chip; and
each of the first pin, the second pin, the third pin and the fourth pin is electrically connected to each of the two connection terminals through the switch control circuit.

17. The aerosol generating device of claim 16, wherein the switch control circuit is configured to, based on a first control instruction from the control chip, control both the first pin and the third pin to be electrically connected to the positive output terminal and control both the second pin and the fourth pin to be electrically connected to the negative output terminal, so that the N−1 heating parts are electrically connected in parallel.

18. The aerosol generating device of claim 16, wherein the switch control circuit is configured to, based on a second control instruction from the control chip, control the first pin to be electrically connected to the positive output terminal, control the fourth pin to be electrically connected to the negative output terminal, and control each of the second pin and the third pin to be electrically disconnected from each of the positive output terminal and the negative output terminal, so that the N−1 heating parts are electrically connected in series.

19. The aerosol generating device according to claim 14, wherein the power supply device comprises a gas guide tube, a battery, a fixing cotton, a silica gel member for a breath detector, a printed circuit board assembly (PCBA), and a gas passage needle;
a first end of the gas guide tube is sealed with a second end of the atomization device;
the battery is disposed in the gas guide tube, and the fixing cotton is disposed between an outer side of the battery and an inner wall of the gas guide tube;
a second end of the gas guide tube is sealed with the silica gel member;
the PCBA is fixed on a side of the silica gel member away from the battery and is electrically connected to the battery; and
the gas passage needle is disposed on the silica gel member.

20. The aerosol generating device according to claim 19, wherein an oil absorbing cotton is provided between the second end of the atomization device and the battery.
